(19) United States
(12) Patent Application Publication
(10) Pub. No.: US 2005/0100574 A1
(43) Pub. Date: May 12, 2005

(54) Antibacterial polyester resin composition

(76) Inventors: Koji Furukawa, Itami-shi (JP); Noriyasu Tamura, Itami-shi (JP); Satoshi Segawa, Itami-shi (JP); Sumio Hamada, Itami-shi (JP)

Correspondence Address: BIRCH STEWART KOLASCH & BIRCH, PO BOX 747, FALLS CHURCH, VA, 22040-0747, US

(21) Appl. No.: 10/650,913

(22) Filed: Aug. 29, 2003

(30) Foreign Application Priority Data
Jan. 17, 2003 (JP) 2003-010080

(51) Int. Cl. A01N 25/00

(52) U.S. Cl. 424/405

(57) ABSTRACT

An antibacterial polyester resin composition which comprises an inorganic antibacterial agent, a thermoplastic polyester resin as a base resin and 5 to 50% by weight of a low molecular weight polyester resin having a number average molecular weight of 1800 to 3000 based on the inorganic antibacterial agent as a vehicle for dispersing the inorganic antibacterial agent.

### BACKGROUND OF THE INVENTION

1. Technical Field

The present invention relates to an antibacterial polyester resin composition useful for obtaining, for example, a polyester fiber excellent in antibacterial property.

2. Description of the Related Arts

Hitherto, polyester resins are broadly used in fields of fibers, films, moldings and the like because of excellent mechanical and chemical properties. In recent years, however, polyester resin articles also having an antibacterial property, are desired with diversification of consumer's sense of value and rising of hygienic awareness.

As methods of making a resin antibacterial, various methods are known, among them, it is generally used that a method of processing an antibacterial resin composition prepared by mixing and dispersing a particulate inorganic antibacterial agent in the resin, and in this case, it was general that a method of diluting a master batch in which the antibacterial agent has been previously dispersed by kneading as means for dispersing the particulate inorganic antibacterial agent in the resin. As an antibacterial resin composition prepared by mixing and dispersing an inorganic antibacterial agent in a resin, for example, an antibacterial resin composition characterized by compounding a specific combination of more than one kinds of antibacterial agents with a resin, is proposed (JP 2002-20632 A). However, though the antibacterial resin composition was excellent in dispersibility of the antibacterial agents in a polyolefin resin, the dispersibility was insufficient when a polyester resin was used as the resin. When the polyester resin was used, not only the antibacterial property was not exhibited efficiently, but also there was sometimes raised problems in processability, for example, in a fiber field, the maintenance became troublesome because, when a molten material before spinning was passed through a filter, the filter was easily choked, and yarn was snapped off during spinning.

### SUMMARY OF THE INVENTION

An object of the present invention is to provide an antibacterial polyester resin composition as a master batch or a resin material, which is good in dispersibility and can retain excellent processability.

The present inventors intensively studied to solve the above-described problems, as results, found that the dispersibility of the inorganic antibacterial agent in a thermoplastic polyester resin was markedly improved by adding a specified amount of a low molecular weight thermoplastic polyester resin as a vehicle for dispersing the agent, and thus completed the present invention.

Namely, the present invention relates to an antibacterial polyester resin composition which comprises an inorganic antibacterial agent, a thermoplastic polyester resin as a base resin, and 5 to 50% by weight of a low molecular weight polyester resin having a number average molecular weight of 1800 to 3000 based on the inorganic antibacterial agent, as a vehicle for dispersing the inorganic antibacterial agent.

### DETAILED DESCRIPTION OF THE INVENTION

The antibacterial polyester resin composition of the present invention may be a resin material for obtaining antibacterial polyester resin molded articles, or a master batch for obtaining the resin material. Namely, when the composition is pellet or particle obtained by kneading and, for example, pelletizing or pulverizing a mixture which is obtained by mixing components such as the antibacterial agent, the vehicle and optionally additives described after, with a small amount of the thermoplastic polyester resin as a base resin, the composition of the present invention is usually a master batch. On the other hand, when the composition is a composition obtained by kneading and diluting the above-described master batch with a thermoplastic polyester resin as a base resin, the composition of the present invention is a resin material.

The inorganic antibacterial agent used in the present invention is not particularly limited, and, for example, (i) an antibacterial agent prepared by supporting at least one metal ion selected from the group consisting of a silver ion, cupper ion, zinc ion and tin ion, on zeolite, (ii) an antibacterial agent containing a phosphorous salt containing a silver ion, as an effective ingredient, (iii) an antibacterial agent composed of fusible glass powder containing a silver ion, and the like are illustrated. Specific examples of the above-described antibacterial agent (i) include antibacterial agents described in, for example, JP 63(1988)-28402B, specific examples of the above-described antibacterial agent (ii) include antibacterial agents described in, for example, JP 06(1994)-10126B, and specific examples of the above-described antibacterial agent (iii) include antibacterial agents described in, for example, JP03(1991)-124810A. Among these antibacterial agents, an antibacterial agent which is prepared by supporting a silver ion on zeolite, is preferred. The number average particle diameter of the inorganic antibacterial agent is not particularly limited, and preferably 0.01 to 3 μm. Besides, one or more kinds of the inorganic antibacterial agents may be used.

The content of the inorganic antibacterial agent in the antibacterial polyester resin composition is not particularly limited, and when the composition of the present invention is a master batch, the content of the inorganic antibacterial agent based on the composition (master batch) is preferably 10 to 60% by weight, more preferably 15 to 40% by weight. Namely, a preferable mode of the antibacterial polyester resin composition is a master batch containing 10 to 60% by weight of the antibacterial agent based on the master batch. In the present invention, the composition can disperse and contain the antibacterial agent of high concentration such the range mentioned above because the dispersibility of the antibacterial agent is good.

In addition, when the composition is a resin material, in other words, when the composition is used for molding to produce molded articles without diluting the composition with a base polyester resin, the concentration of the antibacterial agent may be properly determined taking account of use of the composition and the like.

In the present invention, said low molecular weight thermoplastic polyester resin as a vehicle is a polymer having ester bond, such as ester unit with dicarboxylic acid component and glycol component condensed, or ester unit with dicarboxylic acid component, glycol component, and hydroxycarboxylic acid component condensed, etc. Examples of the dicarboxylic acid include aromatic dicarboxylic acid such as terephthalic acid, isophthalic acid, phthalic acid, 2,6-naphthalenedicarboxylic acid, 4,4′-diphenyldicarboxylic acid, etc., or aliphatic dicarboxylic acid such as adipic acid, sebacic acid, etc. Examples of the glycol includes ethylene glycol, propylene glycol, diethylene glycol, triethylene glycol, 1,3-propanediol, 1,4-butane diol, 1,6-hexanediol, neopentyl glycol, 1,4-cyclohexene dimethanol, etc., and examples of hydroxycarboxylic acid include p-hydroxybenzoic acid, etc. The low molecular weight thermoplastic polyester resin used as a vehicle may be one kind, or two or more kinds.

It is necessary in the present invention that the number average molecular weight of the low molecular weight thermoplastic polyester resin is 1,800 to 3,000. The resin composition having a good dispersibility and excellent processability can be obtained by using the low molecular weight thermoplastic polyester resin having a number average weight molecular weight within the specified range.

When the number average weight molecular weight is less than 1,800, it may become difficult to obtain the composition of the high concentration of the antibacterial agent because the compatibility with the thermoplastic polyester resin as a base resin becomes poor and the dispersibility is poor. On the other hand, when exceeds 3,000, the dispersibility and processability deteriorate.

Further, the low molecular weight thermoplastic polyester resin preferably has a melting point of 40 to 70° C. When the melting point is lower than 40° C., operability including a handling property during processing is not good because it may exhibit a molten state at ordinary temperature, therefore it is not preferable. On the other hand, it is not preferable that the softening point of the low molecular weight thermoplastic polyester resin is higher than that of the base resin because the low molecular weight thermoplastic polyester resin as a vehicle is used as a binder for adsorbing the antibacterial agent to the base resin. Therefore, it is preferable to use the base resin having a softening point of higher than 70° C. and the low molecular weight thermoplastic polyester resin having a softening point of 70 or lower.

In the present invention, it is essential to contain the vehicle of 5 to 50% by weight based on the antibacterial agent (100% by weight). When the amount of the vehicle is less than 5% by weight, a dispersibility deteriorates due to bad wettability to the particulate antibacterial agent. On the other hand, when more than 50% by weight, the master batch in a large amount is required to exhibit the desired performance because the content of the antibacterial agent in the master batch becomes low.

In the present invention, the thermoplastic polyester resin as the base resin is not particularly restricted, and there are illustrated thermoplastic polyester resins which are exemplified as the vehicle (with proviso that the number average molecular weight is not restricted because the resins are used in different use from the vehicle) and have a softening point higher than that of the low molecular weight thermoplastic polyester resin as the vehicle. In addition, the thermoplastic polyester resin as the base resin may be crystalline or non-crystalline. The kind of the base resin used may be the same as or different from that of the vehicle, but is preferably the same kind as the vehicle. The base resin may be one kind or a mixture of two or more kinds of thermoplastic polyesters.

When the antibacterial thermoplastic polyester resin of the present invention is a master batch, the content of the antibacterial agent in the master batch is preferably adjusted to a range of 10 to 60% by weight, and specifically, the content of the base resin in the master batch is preferably 10 to 89% by weight. On the other hand, when the antibacterial thermoplastic polyester resin of the present invention is a resin material in which the master batch is diluted with the base resin, the ratio of the base resin compounded is preferably 9900% by weight or less, more preferably 900% by weight or less based on the master batch (100% by weight). Further, in this case, the amount of the base resin used for dilution is preferably 99000% by weight or less, more preferably 9000% by weight or less based on the antibacterial agent (100% by weight) contained in the master batch.

The antibacterial thermoplastic polyester resin of the present invention optionally also contain various additives within a range in which the effect of the present invention is not damaged.

The additives are used for the purpose of improving resin properties such as processability, flexibility, elasticity, brittleness, manageability, etc., resin performance such as stability, durability, inflammability, heat insulation ability, etc., workability such as mold releasibility, kneading ability, etc., and are not particularly limited unless they are decomposed in the molten resin. Examples thereof include a plasticizer, antioxidant, UV absorber, light stabilizer, flame retardant, antistatic agent, copper inhibitor, metal deactivator, tackifier, lubricant, slipping agent, internal mold releasing agent, defogging agent, perfuming agent, surfactant, wetting agent, preservative, mildew resistance agent, filler, reinforcing agent, stabilizer, heat insulator, foaming agent, anti-dumping material, impact resistance improver, surface treating agent, dispersing agent, etc. The additive used may be one kind or more.

When the composition of the present invention is the master batch, its shape is not particularly limited, and is, for example, particle-like or pellet-like. The master batch of the composition can be obtained by kneading a mixture of the inorganic antibacterial agent, the vehicle and optionally the additives with a small amount of the base resin with a Banbury mixer, pressure type kneader, three roll mill or high speed mixer to obtain a preliminarily dispersed material, then preparing a master batch from the preliminarily dispersed material. Particularly, in the case of mixing and dispersing by means of a Banbury mixer, pressure type kneader or three roll mill, firstly, a mixture not containing the base resin is kneaded, the kneaded mixture is pulverized with a hummer mill, feather mill or the like so that the particle diameter becomes within a range of, for example, 4 to 20 mesh (4.7 to 0.83 mm) to obtain a preliminary dispersed material, and then the preliminary dispersed material is kneaded with a single- or twin-screw extruder or the like to obtain a master batch. On the other hand, in a case of mixing and dispersing by means of a high speed mixer, firstly, a vehicle is added to a base resin heated, stirred and mixed, then, when the vehicle is melted, the remind components (antibacterial agent and optionally the additives) are added thereto to obtain a preliminary dispersed material, and then the preliminary dispersed material is kneaded with a single- or twin-screw extruder or the like to obtain a master batch. In the case that the master batch obtained by the above-described method is further pulverized, for example, a hammer mill or pin mill may be used.

The antibacterial thermoplastic polyester resin composition of the present invention as a resin material can be obtained by heating and melting the master batch together with a thermoplastic polyester resin to dilute the master batch.

The antibacterial thermoplastic polyester resin composition of the present invention is useful for use of, for example, fibers, films, molded articles and the like.

### EXAMPLE

The present invention will be described in more detail referring to Examples below, but is not limited thereto.

### Example 1

75 Parts by weight of a pulverized polyethylene terephthalate resin (“Mitsui PET J-125”, manufactured by Mitsui Chemicals Inc.) was stirred under heating with a high speed mixer, then 5 parts by weight of a low molecular weight polyester resin (number average molecular weight: 2000, softening point: 53° C.) was added thereto when the temperature of the pulverized polyethylene terephthalate resin reached 140° C., and then stirring was further continued to obtain a mixture. Next, 20 parts by weight of a silver-zeolite type antibacterial agent (average particle diameter: 1.3 μm) was added and mixed with said mixture, then the resulting mixture was kneaded and pelletized with a twin screw extruder to obtain a resin composition (master batch) of the present invention. The obtained resin composition was subjected to the following evaluation. As the result, the dispersibility was good since a filtration pressure was 1 kg/cm², and the limiting viscosity was 0.53. Further, choking of a filter and snapping of fiber were not observed during spinning.

[Dispersibility (Filtration Pressure)]

The obtained resin composition was passed through a melt spinning tester for 100 minutes without diluting under conditions of a passage temperature of 300%, passage sectional area of 1 cm², 20 μm mesh filter and discharge rate of 10 g/minute, an increased pressure value after 100 minutes (ΔP₁₀₀) was measured, and the value obtained was determined as a filtration pressure. The lower the filtration pressure is, the better the dispersibility is. But, specifically, the filtration pressure of 10 kg/cm² or lower is permissible range.

[Limiting Viscosity]

The obtained composition (master batch) was dissolved in o-chlorophenol at a concentration of 5 g/L, and measured with an Ostwald viscometer.

[Processability (Spinning Property)]

Using a mixture in which 10 parts by weight of the master batch was mixed with 90 parts by weight of a polyethylene terephthalate resin, spinning was carried out with a melt spinning tester under conditions of a passage temperature of 300° C., 20 μm mesh filter, spinning nozzle having a hole diameter of 0.5 mm and 28 holes and discharge rate of 10 g/minute, and it was confirmed whether choking of a filter and snapping of fiber were observed or not.

### Comparative Example 1

80 Parts by weight of a pulverized polyethylene terephthalate resin (“Mitsui PET J-125”, manufactured by Mitsui Chemicals Inc.) was stirred under heating with a high speed mixer, then without adding the vehicle used in Example 1, 20 parts by weight of a silver-zeolite type antibacterial agent (particle diameter: 1.3 μm) was added and mixed therewith, and the resulting mixture was kneaded and pelletized with a twin screw extruder to obtain a resin composition for comparison. The obtained resin composition was subjected to the same evaluation as in Example 1. As the result, a dispersibility was bad since a filtration pressure was 30 kg/cm², and the limiting viscosity was 0.51. Further, choking of a filter frequently occurred and the processability was bad.

### Comparative Example 2

A resin composition for comparison was obtained by carrying out a experiment in the same manner as in Example 1 except that magnesium stearate was used in stead of the low molecular weight polyester resin as the vehicle. The evaluation of the obtained resin composition was carried out in the same manner as in Example 1. As the result, the filtration pressure was 15 kg/cm². Though the dispersibility was slightly improved compared to Comparative Example 1, it was insufficient yet. Further, the limiting viscosity was 0.38, and a remarkable decrease in a viscosity compared to Example 1 was observed. Moreover, snapping of fiber frequently occurred, and the processability was bad.

According to the present invention, an antibacterial thermoplastic polyester resin composition excellent in dispersibility and processability, can be provided as a master batch or resin material. Further, because the antibacterial thermoplastic polyester resin composition of the present invention is good in dispersibility, a master batch in which an antibacterial agent at a high concentration is contained and dispersed therein, can be obtained.

1. An antibacterial polyester resin composition which comprises an inorganic antibacterial agent, a thermoplastic polyester resin as a base resin and 5 to 50% by weight of a low molecular weight polyester resin having a number average molecular weight of 1800 to 3000 based on the inorganic antibacterial agent as a vehicle for dispersing the inorganic antibacterial agent.

2. The antibacterial polyester resin composition according to claim 1, wherein the composition is a master batch containing 10 to 60% by weight of the inorganic antibacterial agent and 10 to 89% by weight of the base resin in the composition.

3. The antibacterial polyester resin composition according to claim 1, wherein the inorganic antibacterial agent has an number average particle diameter of 0.01 to 3 μm.

4. The antibacterial polyester resin composition according to claim 1, wherein the low molecular weight polyester resin as the vehicle has a softening point of 40 to 70° C. and the thermoplastic polyester resin as the base resin has a softening point of higher than 70° C.

5. The antibacterial polyester resin composition according to claim 2, wherein the low molecular weight polyester resin as the vehicle has a softening point of 40 to 70° C. and the thermoplastic polyester resin as the base resin has a softening point of higher than 70° C.

6. An antibacterial polyester resin composition as a resin material obtained by a process comprising diluting the composition of claim 2 as a master batch with a thermoplastic polyester resin as a base resin of up to 9900% by weight based on the composition of claim 2, wherein the amount of the thermoplastic polyester resin used for diluting is up to 99000% by weight based on the antibacterial agent contained in the master batch.

7. The antibacterial polyester resin composition as a resin material according to claim 6, wherein the amount of the thermoplastic polyester resin is up to 900% by weight based on the master batch and the amount of the thermoplastic polyester resin is up to 9000% by weight based on the antibacterial agent.
